(19) United States
(12) Patent Application Publication
(10) Pub. No.: US 2006/0113898 A1
(43) Pub. Date: Jun. 1, 2006

(54) Transparent substrate, electro-optical device, image forming device and method for manufacturing electro-optical device

(75) Inventor: Naoyuki Toyoda, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/257,461

(22) Filed: Oct. 24, 2005

(30) Foreign Application Priority Data
Nov. 29, 2004 (JP) 2004-343433

(51) Int. Cl. B41J 2/44; B41J 2/45; B41J 2/455; G03G 15/04; H05B 33/02; H05B 33/14

(52) U.S. Cl. 313/504; 430/311; 430/321; 359/619

(57) ABSTRACT

A transparent substrate including: a light incident surface; a light extract surface; a micro lens formed on the light extract surface; and a strength reinforcement part compensating a mechanical strength of the transparent substrate, the strength reinforcement part surrounding the micro lens and being protruded from the light extract surface, and light entered to a side of the light incident surface being emitted from a side of light extract surface.

### BACKGROUND

1. Technical Field

The present invention relates to a transparent substrate, an electro-optical device, an image forming device, and a method for manufacturing the electro-optical device.

2. Related Art

In image forming devices using an electro photographic method, exposure heads are used as an electro-optical device that exposures a photosensitive drum, which serves as an image carrier, so as to form a latent image. Recently, in order to make the exposure head thin and light, one is proposed that employs an organic electroluminescent device (organic EL device) as the light-emitting source of the exposure head.

Particularly, in this sort of exposure head, so-called a bottom-emission structure is adopted due to the convenience allowing a range of material selection for the exposure head to be expanded. In the bottom-emission structure, an organic EL device is formed on one side surface (light-emitting device forming surface) of a transparent substrate, and light emitted from the organic EL device is taken out from the other side surface (light extract surface) opposing to the light-emitting device forming surface.

However, in the bottom-emission structure, capacitances and various wirings for making the organic EL device emit light, etc., are formed between the light extract surface and the organic EL device. This structure causes the problem in that the aperture rate of the organic EL device is decreased, lowering a light extract efficiency.

Consequently, in the exposure head, a lens that converges light emitted from the organic EL device, so-called a micro lens, is proposed in an example of related art so as to be provided on the light extract surface in order to improve the light extract efficiency. According to the example of related art, a micro lens is formed by discharging a curable resin to the light extract surface opposing to the organic EL device, and then curing the discharged resin.

JP A-2003-291404 is the example of related art.

However, in the exposure head, the micro lens is spaced apart from the organic EL device by the distance between the light-emitting device forming surface and the light extract surface, namely, by the thickness of the transparent substrate. Accordingly, the aperture angle, which is an angle formed from the center position of the organic EL device to the diameter of the micro lens, of the micro lens with respect to the organic EL device is reduced by the thickness of the transparent substrate, resulting in the problem in that the efficiency of extract light emitted from the organic EL device is sacrificed by the thickness of the transparent substrate.

This problem may be reduced by thinning the thickness of the transparent substrate on which the organic EL device and the micro lens are formed. However, if the thickness of the transparent substrate is thinned, its mechanical strength becomes insufficient. As a result, the transparent substrate has a risk of being broken when the organic EL device or the micro lens is formed. In addition, the thinner thickness makes the light extract surface difficult to be processed into flat and smooth surface. The formed position or shape of the micro lens has a risk of being varied by deteriorating the roughness of the surface (arithmetic average roughness).

### SUMMARY

An advantage of the invention is to provide a transparent substrate, an electro-optical device, and an image forming device that improve a light extract efficiency with avoiding variations in a shape or formed position of a micro lens, and to provide a method for manufacturing the electro-optical device.

A transparent substrate according to a first aspect of the invention includes: a light incident surface; a light extract surface; a micro lens formed on the light extract surface; and a strength reinforcement part compensating a mechanical strength of the transparent substrate, the strength reinforcement part surrounding the micro lens and being protruded from the light extract surface, and light entered to a side of the light incident surface is emitted from a side of light extract surface.

According to the transparent substrate, the mechanical strength of the transparent substrate can be compensated by the strength reinforcement part formed as protruded from the light extract surface. Therefore, the thickness of the transparent substrate can be preliminarily thinned by the formed strength reinforcement part. The thinned thickness allows the distance between the light incident surface and the light extract surface to be shortened. Further, since the micro lens is formed on the light extract surface that has been formed in advance, the roughness of the light extract surface can be lessened, for example, as compared with the light extract surface formed by grinding or the like.

Accordingly, the aperture angle of the micro lens with respect to the light incident surface can be increased with avoiding variations in shape and formed position of the micro lens. As a result, the efficiency of extract light entered from the side of the light incident surface can be increased.

In the transparent substrate, the strength reinforcement part includes a through hole reaching to the light extract surface, the strength reinforcement part being deposited on the light extract surface, and the micro lens is formed in the through hole.

According to the transparent substrate, since the micro lens is formed in the through hole in the strength reinforcement layer formed on the light extract surface, the strength reinforcement part compensating the mechanical strength of the transparent substrate can be formed in the region excluding the region in which the through hole is formed. Accordingly, the size of the strength reinforcement part can be increased and the thickness of the transparent substrate can be further thinned. As a result, the efficiency of extract light entered from the side of the light incident surface can be further improved.

In the transparent substrate, the micro lens has a hemispherical optical surface, and the through hole is a circular hole having an inner diameter corresponding to an aperture diameter of the micro lens.

According to the transparent substrate, since the through hole is formed as the circular hole having the inner diameter corresponding to the aperture diameter of the micro lens, the strength reinforcement part compensating the mechanical strength of the transparent substrate can be formed in the region excluding the region in which the micro lens is formed. Accordingly, the strength reinforcement part can be formed almost all the surface of the light extract surface and the thickness of the transparent substrate can be further thinned. As a result, the efficiency of extract light entered from the side of the light incident surface can be further improved.

In the transparent substrate, the transparent substrate is a glass substrate, and the strength reinforcement part is a photosensitive glass paste layer deposited on the light extract surface, and is burned after patterning the through hole therein.

According to the transparent substrate, since the strength reinforcement part is formed by burning the glass paste layer coated on the light extract surface, the adhesiveness of the strength reinforcement part with respect to the transparent substrate can easily be secured. In addition, the coefficients of thermal expansion of the transparent substrate and the strength reinforcement part can to be approximately the same. Accordingly, the mechanical strength of the transparent substrate can be increased and the thickness of the transparent substrate can be further thinned. As a result, the efficiency of extract light entered from the side of the light incident surface can be further improved.

An electro-optical device according to a second aspect of the invention includes: a transparent substrate having a light-emitting device forming surface and a light extract surface opposing to the light-emitting device forming surface; a light-emitting device formed on the light-emitting device forming surface; a micro lens formed at a position on the light extract surface and opposing to the light-emitting device; and a strength reinforcement part compensating a mechanical strength of the transparent substrate, the strength reinforcement part surrounding the micro lens, light emitted from the light-emitting device being emitted from a side of the light extract surface.

According to the electro-optical device, the mechanical strength of the transparent substrate can be compensated by the strength reinforcement part formed as protruded from the light extract surface. Therefore, the thickness of the transparent substrate can be preliminarily thinned by the formed strength reinforcement part, allowing the distance between the light-emitting device forming surface and the light extract surface to be shortened. Further, since the micro lens is formed on the light extract surface that has been formed in advance, the roughness of the light extract surface can be lessened, for example, as compared with the light extract surface formed by grinding or the like.

Accordingly, the aperture angle of the micro lens with respect to the light incident surface can be increased with avoiding variations in shape and formed position of the micro lens. As a result, the efficiency of extract light emitted from the light-emitting device can be increased.

In the electro-optical device, the strength reinforcement part includes a through hole reaching to the light extract surface, the strength reinforcement part being deposited on the light extract surface, and the micro lens is formed in the through hole.

According to the electro-optical device, since the micro lens is formed in the through hole in the strength reinforcement layer formed on the light extract surface, the strength reinforcement part compensating the mechanical strength of the transparent substrate can be formed in the region excluding the region in which the through hole is formed. Accordingly, the size of the strength reinforcement part can be increased and the thickness of the transparent substrate can be further thinned. As a result, the efficiency of extract light emitted from the light-emitting device can be further improved.

In the electro-optical device, the micro lens is a convex shaped lens having a hemispherical optical surface, and the through hole is a circular hole having an inner diameter, corresponding to an aperture diameter of the micro lens.

According to the electro-optical device, since the through hole is formed as the circular hole having the inner diameter corresponding to the aperture diameter of the micro lens, the strength reinforcement part compensating the mechanical strength of the transparent substrate can be formed in the region excluding the region in which the micro lens is formed. Accordingly, the strength reinforcement part can be formed almost all the surface of the light extract surface and the thickness of the transparent substrate can be further thinned. As a result, the efficiency of extract light emitted from the light-emitting device can be further increased.

In the electro-optical device, the transparent substrate is a glass substrate, and the strength reinforcement part is a photosensitive glass paste layer deposited on the light extract surface, and is burned after patterning the through hole therein.

According to the electro-optical device, since the strength reinforcement part is formed by burning the glass paste layer deposited on the light extract surface, the adhesiveness of the strength reinforcement part with respect to the transparent substrate can easily be secured. In addition, the coefficients of thermal expansion of the transparent substrate and the strength reinforcement part can be approximately the same. Accordingly, the mechanical strength of the transparent substrate can be increased and the thickness of the transparent substrate can be further thinned. As a result, the efficiency of extract light emitted from the light-emitting device can be further improved.

In the electro-optical device, the light-emitting device is an electroluminescent device including: a transparent electrode formed on a side of the light extract surface; a backside electrode formed so as to oppose to the transparent electrode; and a light-emitting layer formed between the transparent electrode and the backside electrode.

According to the electro-optical device, the efficiency of extract light emitted from the electroluminescent device can be increased.

In the electro-optical device, the light-emitting layer is formed with the organic material, and the electroluminescent device is the organic electro luminescent device.

According to the electro-optical device, the efficiency of extract light emitted from the electroluminescent device can be increased.

An image forming device according to a third aspect of the invention includes: a charging unit charging an outer circumferential surface of an image carrier; an exposure unit exposing the charged outer circumferential surface of the image carrier so as to form a latent image; a development unit developing a developed image by supplying a colored particle to the latent image; and a transfer unit transferring the developed image to a transfer medium. The exposure unit is provided with the electro-optical device.

According to the image forming device, the exposure unit that exposes the charged, image carrier is provided with the electro-optical device. As a result, the efficiency of extract exposure light emitted from the light-emitting device can be increased.

A method for manufacturing an electro-optical device according to a fourth aspect of the invention includes: depositing a strength reinforcement layer on a light extract surface of a transparent substrate; forming a through hole reaching to the light extract surface in the strength reinforcement layer so as to form a strength reinforcement part compensating a mechanical strength of the transparent substrate; forming a light-emitting device at a position on a light-emitting device forming surface opposing to the light extract surface, the position opposing to the through hole; and forming a micro lens in the through hole, the micro lens emitting light emitted from the light-emitting device.

According to the method for manufacturing an electro-optical device, the thickness of the transparent substrate can be thinned by the strength reinforcement part, which is formed on the light extract surface of the transparent substrate, compensating the mechanical strength of the transparent substrate, allowing the distance between the light extract surface and the light-emitting device forming surface to be shortened. Therefore, the aperture angle of the micro lens with respect to the light-emitting device can be increased. As a result, an electro-optical device can be manufactured that increases the efficiency of extract light emitted from the light-emitting device.

In the method for manufacturing an electro-optical device, the light-emitting device is an electroluminescent device having a light-emitting layer. The light-emitting layer is formed by discharging a droplet composed of a light-emitting layer forming material in a bulkhead and curing the discharged droplet.

According to the method for manufacturing an electro-optical device, since the light-emitting layer is formed by the droplet discharged in the bulkhead from the droplet discharging device, an electro-optical device that increases the efficiency of extract light emitted from the electroluminescent device can be manufactured by a further simplified method.

In the method for manufacturing an electro-optical device, the strength reinforcement layer made of a photosensitive material is exposed with the bulkhead as a mask and developed so as to form the through hole.

According to the method for manufacturing an electro-optical device, since the through hole is patterned with the bulkhead as a mask, the positions of the bulkhead and the through hole can be aligned. As a result, the positions of the light-emitting layer and the micro lens can be aligned. Therefore, the efficiency of extract light emitted from the electro-optical device can be firmly increased with avoiding variations in formed position of the micro lens.

In the method for manufacturing an electro-optical device, a bulkhead layer made of a photosensitive material is exposed with the strength reinforcement part as a mask and developed so as to form the bulkhead.

According to the method for manufacturing an electro-optical device, since the bulkhead is patterned with the strength reinforcement part as a mask, the positions of the bulkhead and the through hole can be aligned. As a result, the positions of the light-emitting layer and the micro lens can be aligned. Therefore, the efficiency of extract light emitted from the electro-optical device can be firmly increased with avoiding variations in formed position of the micro lens.

In the method for manufacturing an electro-optical device, the strength reinforcement layer made of a photosensitive material and the bulkhead layer made of a photosensitive material are simultaneously exposed so as to form patterns corresponding to the through hole on the strength reinforcement layer and the bulkhead layer, and exposed so as to form the through hole and the bulkhead.

According to the method for manufacturing an electro-optical device, since the through hole and the bulkhead are formed by simultaneously exposing the strength reinforcement layer and the bulkhead layer, the position of the micro lens formed in the through hole and the position of the light-emitting layer formed in the bulkhead can be aligned. Therefore, the efficiency of extract light emitted from the electro-optical device can be firmly increased with avoiding variations in formed position of the micro lens.

### BRIEF DESCRIPTION OF THE DRAWINGS

The invention will be described with reference to the accompanying drawings, wherein like numbers reference like devices.

FIG. 1 is a schematic side sectional-view illustrating an image forming device according to a first embodiment of the invention.

FIG. 2 is a schematic front sectional-view illustrating an exposure head according to the first embodiment of the invention.

FIG. 3 is a schematic plan view illustrating the exposure head according to the first embodiment of the invention.

FIG. 4 is an enlarged side sectional-view illustrating the exposure head according to the first embodiment of the invention.

FIG. 5 shows a process of the exposure head according to the first embodiment of the invention.

FIG. 6 shows the process of the exposure head according to the first embodiment of the invention.

FIG. 7 shows the process of the exposure head according to the first embodiment of the invention.

FIG. 8 shows the process of the exposure head according to the first embodiment of the invention.

FIG. 9 is a flow chart illustrating the process of the exposure head according to a second embodiment of the invention.

FIG. 10 shows the process of the exposure head according to the second embodiment of the invention.

FIG. 11 shows the process of the exposure head according to the second embodiment of the invention in a modification example.

FIG. 12 shows the process of the exposure head according to the second embodiment of the invention in a modification example.

### DESCRIPTION OF EXEMPLARY EMBODIMENTS

### First embodiment

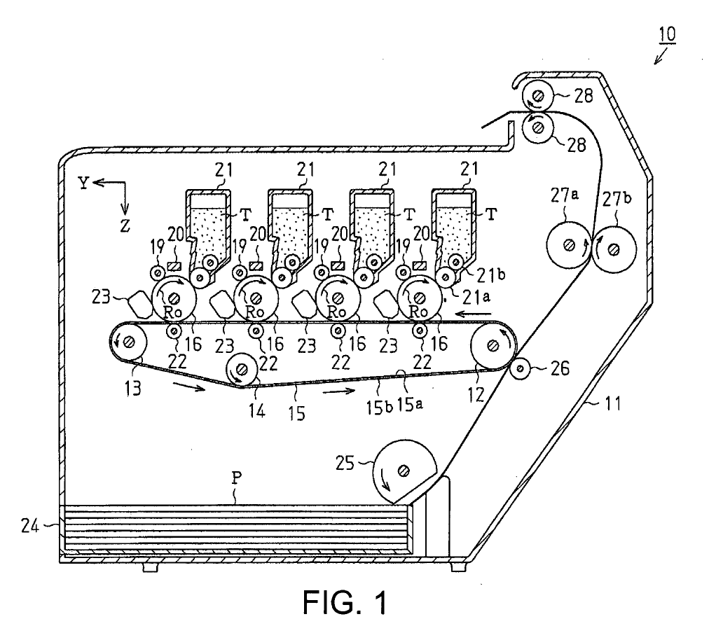

A first embodiment of the invention will be explained below with reference to FIGS. 1 through 8. FIG. 1 is a schematic side sectional-view illustrating an electrophotographic printer serving as an image forming device.

Electrophotographic Printer

As shown in FIG. 1, an electrophotographic printer 10 (hereinafter, simply referred to as the printer 10) is provided with a chassis 11 formed in a box shape. Inside the chassis 11, a driver roller 12, a driven roller 13, and a tension roller 14 are provided. In addition, an intermediate transfer belt 15, which serves as a transfer medium, is stretched with respect to each of the rollers 12 to 14. The intermediate transfer belt 15 can circularly be driven by the rotation of the driver roller 12 in the direction indicated by the arrow in FIG. 1.

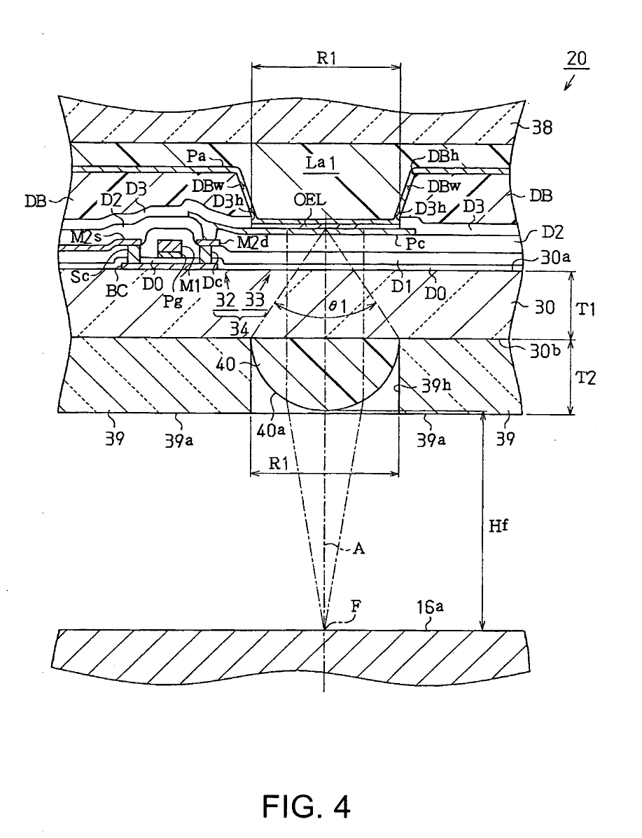

Above the intermediate transfer belt 15, four (4)-photosensitive drums 16, which serve as an image carrier, are rotatably provided side-by-side in the stretched direction of the intermediate transfer-belt 15 (in a sub scanning direction Y). On the outer circumferential surface of the photosensitive drum 16, a photosensitive layer 16a (refer to FIG. 4) having photoconductivity is formed. The photosensitive layer 16a is charged with plus or minus charge in a dark area. The charge is disappeared from a part on which if light having a given wavelength range is irradiated. Accordingly, the electrophotographic printer 10, which is configured with four photosensitive drums 16, is a tandem type printer.

Around each photosensitive drum 16, each charging roller 19 serving as a charging unit, each organic electroluminescent array exposure head 20 (hereinafter, simply referred to as the exposure head 20) serving as an electro-optical device included in an exposure unit, each toner cartridge 21 serving as a development unit, each first transfer roller 22 included in a transfer unit, and each cleaning unit 23 are provided.

The charging roller 19, which is a rubber roller having semiconductivity, closely contacts to the photosensitive drum 16. Upon rotating the photosensitive drum 16 while a direct voltage is applied to the charging roller 19, the whole circumferential surface of the photosensitive layer 16a of the photosensitive drum 16 is charged at a given charged potential.

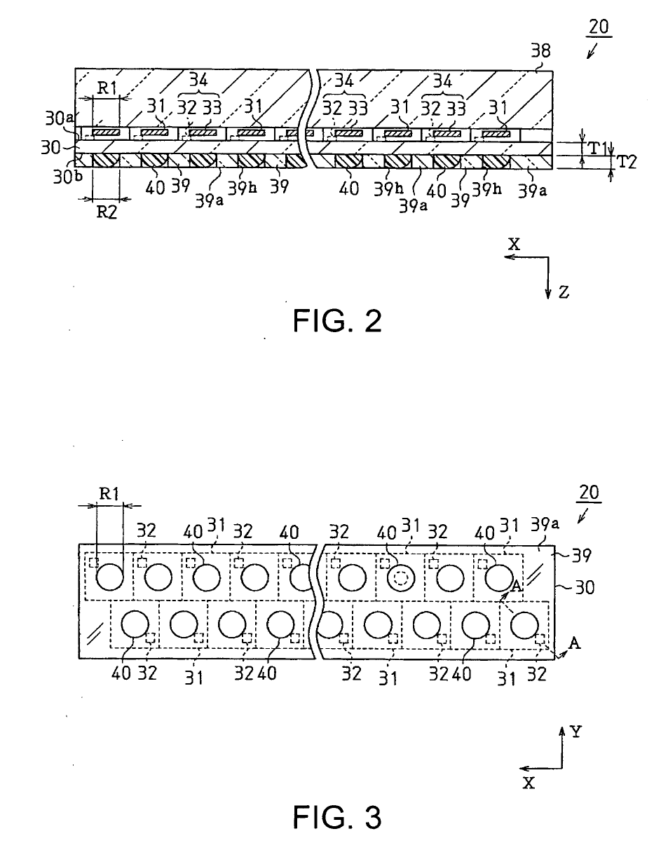

The exposure head 20, which is a light source emitting light having a given wavelength range, is formed like a long plate shape as shown in FIG. 2. The exposure head 20 is positioned at the position apart from the photosensitive layer 16a with a given distance so that its longitudinal direction is in parallel with the axial direction of the photosensitive drum 16 (direction perpendicular to FIG. 1: main scanning direction X). If the exposure head 20 emits the light, which is based on printing data, in the vertical direction Z (refer to FIG. 1) while the photosensitive drum 16 rotates in a rotation direction Ro, the photosensitive layer 16a is exposed by the light having a given wavelength range. As a result, in the photosensitive layer 16a, charges at the exposed part (exposed spot) are disappeared so that an electrostatic image (electrostatic latent image) is formed on its outer circumferential surface. Incidentally, the wavelength range of the light emitted from the exposure head 20 for exposing is matched with the spectral sensitivity of the photosensitive layer 16a. Namely, the peak wavelength of emitted energy of the light emitted from the exposure head 20 for exposing nearly coincides with the peak wavelength of the spectral sensitivity of the photosensitive layer 16a.

The toner cartridge 21 is formed like a box shape, in which a toner T serving as a colored particle having a diameter of approximately 10 μm is stored. In four (4) toner cartridges 21 in the embodiment, the toner T of four (4) colors (black, cyan, magenta, and yellow) is correspondingly stored in the toner cartridges 21. The toner cartridge 21 is equipped with a development roller 21a and supply roller 21b in this order from the photosensitive drum 16. The rotation of the supply roller 21b carries the toner T to the development roller 21a. The development roller 21a charges the toner T carried by the supply roller 21b by friction it with the supply roller 21b so that the charged toner T uniformly adheres on the outer circumferential surface of the development roller 21a.

Then, the supply roller 21b and the development roller 21a are rotated while the bias potential having the opposite polarity of the charged potential is applied to the photosensitive drum 16. Accordingly, the photosensitive drum 16 causes electrostatic adsorption power, which corresponds to the bias potential, between the exposed spot and the development roller 21a (toner T). The toner T that receives the electrostatic adsorption power is transferred to the exposed spot from the outer circumferential surface of the development roller 21c, being adsorbed to the exposed spot. Accordingly, on the outer circumferential surface of each photosensitive drum 16 (each photosensitive layer 16a), a visible image (developed image) having a single color is formed (developed) corresponding to each electrostatic latent image.

Each first transfer roller 22 is provided at the position that opposes to each photosensitive drum 16 and is located on an internal surface 15a of the intermediate transfer belt 15. The first transfer roller 22, which is a conductive roller, rotates so that its outside circumferential surface closely contacts on the internal surface 15a of the intermediate transfer belt 15. When rotating the photosensitive drum 16 and the intermediate transfer belt 15 by applying a direct voltage to the first transfer roller 22, the toner T adsorbed on the photosensitive layer 16a is sequentially transferred and adsorbed to an outer surface 15b of the intermediate transfer belt 15 by the electrostatic adsorption power acting toward the first transfer roller 22. Accordingly, the first transfer roller 22 firstly transfers the developed image formed on the photosensitive drum 16 to the outer surface 15b of the intermediate transfer belt 15. The first transfer of the developed image with a single color is repeated four times by each photosensitive drum 16 and the first transfer roller 22. As a result, a full color image (toner image) is achieved on the outer surface 15b of the intermediate transfer belt 15 by superposing these developed images.

The cleaning unit 23, which is equipped with a light source (not shown) such as LED or the like and a rubber blade, neutralizes the photosensitive layer 16a that has been charged by irradiated light after the first transfer. The cleaning unit 23 mechanically removes the toner T, which remains on the photosensitive layer 16a that has been neutralized, with the rubber blade.

Below the intermediate transfer belt 15, a recoding paper cassette 24 storing recoding paper P is provided. Above the recoding paper cassette 24, a paper-feeding roller 25 is provided that feeds the recoding paper P for the intermediate transfer belt 15. At the position that is located above the paper feeding roller 25 and faces to the driver roller 12, a second transfer roller 26 is provided that is included in the transfer unit. The second transfer roller 26 is a conductive roller such as the first transfer roller 22, presses the backside of the recording paper P and makes the surface of the paper contact the outer side 15b of the intermediate transfer roller 15. When rotating the intermediate transfer roller 15 by applying a direct voltage to the second transfer roller 26, the toner T adsorbed to the outer side 15b of the intermediate transfer roller 15, is moved to the surface of the recording paper P and adsorbed to it. Namely, toner images formed on the outer side 15b of the intermediate transfer roller 15, are secondly transferred to the surface of the paper P by the second transfer roller 26.

A heat roller 27a including a heat source and a pressure roller 27b pressing the roller 27a are installed above the second transfer roller 26. Then, after secondary transfer, the recording paper P is moved to the nip between the heat roller 27a and the pressure roller 27b, softening the toner T transferred to the paper P by heating and hardening it after interfused into the recording paper P. Accordingly, toner images are fixed on the surface of the recording paper P. The recoding paper P on which toner is fixed, is sent out from the chassis 11 by a sending out roller 28.

Therefore, the printer 10 exposes the charged photosensitive layer 16a by the exposure head 20 and forms an electrostatic latent image in the photosensitive layer 16a. Next, the printer 10 forms a single-colored developed image in the photosensitive layer 16a by developing the electrostatic latent image in the photosensitive layer 16a. Further, the printer 10 firstly transfers the developed image in the photosensitive layer 16a into the surface of the intermediate transfer belt 15 and forms a full color toner image on the intermediate transfer belt 15. Finally, the printer 10 completes printing by secondarily transferring the toner image on the intermediate transfer belt 15 onto the recoding paper P and fixing the toner image by adding heat and pressure.

Next, an exposure head 20 equipped with the printer 10 as an electro-optical device will be explained below. FIG. 2 is a front sectional-view illustrating the exposure head 20.

As shown in FIG. 2, the exposure head 20 is provided with a glass substrate 30 as a transparent substrate. The glass substrate 30 is a colorless, transparent non-alkali glass formed as a long substrate of which a width in longitudinal direction (vertical direction in FIG. 2; the main scanning direction X) is almost the same of a width of an axis of the photosensitive drum 16.

Further, in the embodiment, the glass substrate 30 includes an upper surface 30a for forming a light-emitting device (the opposite surface to the photosensitive drum 16) and a bottom surface 30b for extract light (the surface toward the photosensitive drum 16). The thickness of the glass substrate 30 is formed as the minimum thickness (minimum substrate thickness T1), which has an even thickness, and can achieve the light extract surface 30b having a flat and smooth surface (e.g. arithmetic average surface roughness is 2 μm and below). In the embodiment, the minimum substrate thickness T1 is 100 μm, but not limited to this.

First, the surface 30a for forming a light-emitting device of the glass substrate 30 will be explained below. FIG. 3 is a plan view illustrating the exposure head 20 viewing from the surface 30b for extract light. FIG. 4 is a schematic sectional-view taken along dashed line A-A shown in FIG. 3.

As shown in FIG. 2, a plurality of regions 31 for forming pixels is formed on the surface 30a for forming a light-emitting device of the glass substrate 30. Each of regions 31 for forming pixels includes a pixel 34, which has a thin film transistor (TFT) 32 (hereinafter, simply referred to as TFT 32) and an organic electroluminescent device (organic EL device) 33 serving as a light-emitting device. The TFT 32 is turned on by a data signal generated by printing data and makes the organic EL device 33 emit.

As shown in FIG. 4, the TFT 32 is provided with a channel film BC in the bottom layer. The channel film BC is an island like p-type polysilicon film formed on the surface 30a for forming a light-emitting device and provided with activated n-type region (source and drain regions), which is not shown, on both left and right regions in FIG. 4. Namely, the TFT32 is a polysilicon TFT.

In the center of upper side of the channel film BC, a gate insulation film D0, a gate electrode Pg and a gate wiring M1 are formed in order from the surface 30a for forming a light-emitting device. The gate insulation film D0 is an insulation film, which is transparent to light like a silicon oxide, and deposited on almost all the channel film BC and the surface 30a for forming a light-emitting device. The gate electrode Pg is made of low resistive metal such as tantalum and located so as to oppose to the almost center of the channel film B. The gate wiring M1 is a transparent conductive film such as ITO, which is transparent to light, and electrically connects the gate electrode Pg to a data wiring drive circuit not shown in the figure. When the data wiring drive circuit inputs a data signal to the gate electrode Pg via the gate wiring M1, the TFT 32 is turned on based on the signal.

A source contact Sc and a drain contact Dc, which extend upward and are located within the channel film BC, are formed on an upper side of the source region and drain region. Each of contacts Sc and Dc is made of metal lowering contact resistance to the channel film BC. Then, each of contacts Sc and Dc, and the gate electrode Pg (gate wiring M1) are electrically insulated from a first interlayer insulation film D1 made of silicon oxide or the like.

A power source line M2s and anode line M2d, made of low resistive metal like aluminum, are formed on the upper side of each of contacts Sc and Dc. The power source line M2s electrically connects the source contact Sc to a power source for drive, which is not shown. The anode line M2d electrically connects the drain contact Dc to the organic EL device 33. The power source line M2s and anode line M2d are electrically insulated from a second interlayer insulation film D2 made of silicon oxide or the like. Then, the TFT32 is turned on based on a data signal, supplying a drive current corresponding to the data signal to the anode line M2d (the organic EL device 33) from the power source line M2s (the power source for drive).

As shown in FIG. 4, the organic EL device 33 is formed on the second interlayer insulation film D2. An anode Pc, which is a transparent electrode, is formed as the bottom layer of the organic EL device 33. The anode Pc, which is a transparent conductive film such as ITO, is connected to the anode line M2d. On the anode Pc, a third interlayer insulation film D3 made of silicon oxide, by which each anode Pc is electrically insulated each other, is deposited. In the third interlayer insulation film D3, a circular hole (a position adjustment hole D3h), which opens the almost center position of the anode Pc upward, is formed.

On the third interlayer insulation film D3, a bulkhead layer DB is deposited with a resin such like photosensitive polyimide or the like. At the position opposing to the position adjustment hole D3h of the bulkhead layer DB, a conical hole DBh is formed so as to open the hole upward as tapered shape. A bulkhead DBw is formed by the inner circumferential surface of the conical hole D3h.

An organic electroluminescent layer (organic EL layer) OEL made of polymer organic material is formed on the anode Pc and inside of the position adjustment hole D3h. Namely, the outer diameter of the organic EL layer OEL is equal to the diameter (adjustment diameter R1) of the position adjustment hole D3h.

The organic electroluminescent layer OEL is an organic chemical layer including double layers such as a hole transport layer and a light-emitting layer. Further, a cathode Pa, made of metal such as aluminum having light reflection property, is formed as a backside electrode on the upper surface of the organic electroluminescent layer OEL. The cathode Pa covers over almost all the surface located at a side of surface 30a for forming a light-emitting device and are commonly hold by each pixel 34, supplying a potential, which is common for each of organic EL devices 33.

Namely, the organic EL device 33 is an organic electroluminescent device (an organic EL device) provided with the anode Pc, the organic EL layer OEL and the cathode Pa. The inner diameter of the emitting surface (the organic EL device layer OEL) consists of the inner diameter of the position adjustment hole D3h, i.e. the adjustment diameter R1.

A sealing substrate 38, which is adhesively bonded to the cathode Pa (the glass substrate 30) with an adhesive layer La1, is provided on the cathode Pa. The sealing substrate 38 is colorless, transparent non-alkali glass substrate, which is formed in the same size as that of the glass substrate 30 in the plan view, preventing the organic EL layer OEL and various metal wirings from being oxidized.

Then, a driving current corresponding to data signal is applied to the anode line M2d, making the organic EL layer OEL emit light having a luminance corresponding to the driving current. In this time, light emitted to the cathode Pa (upper side in FIG. 4) from the organic EL layer OEL is reflected at the cathode Pa. Hence, most of the light emitted from the organic EL layer OEL is irradiated onto the surface 30b for extract light (the side of the photosensitive drum 16) via the anode Pc, the second interlayer insulation film D2, the first interlayer insulation film D1, the gate insulation film D0 and the glass substrate 30.

Next, the surface 30b for extract light of the glass substrate 30 will be explained below.

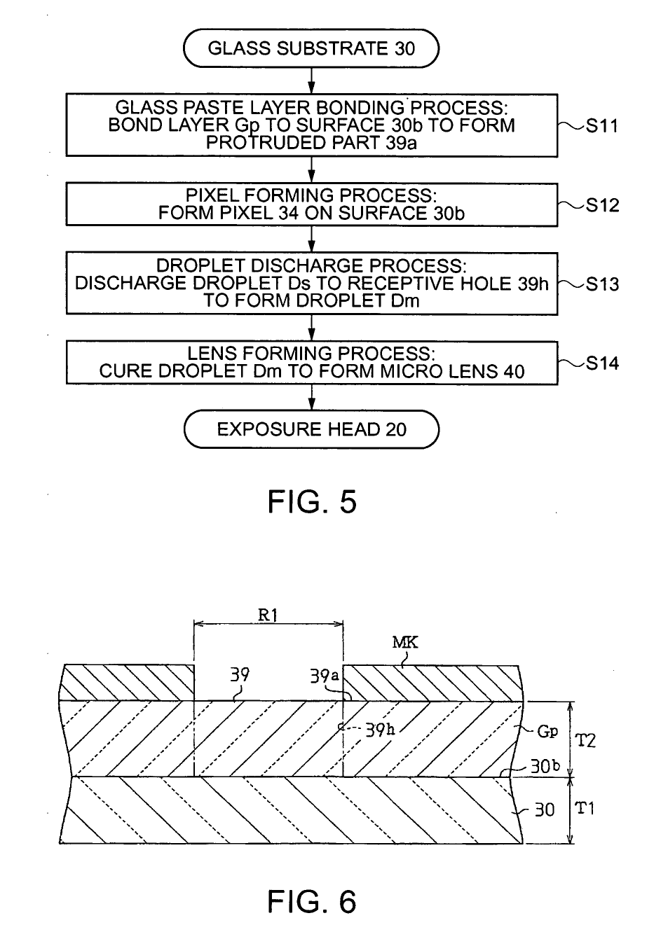

As shown in FIG. 2, a reinforcement glass layer 39 serving as a strength reinforcement layer is formed on the surface 30a for forming a light-emitting device of the glass substrate 30. The reinforcement glass layer 39 is formed by melting and burning glass powders in a glass paste layer Gp, which will be described referring to FIG. 5. In the reinforcement glass layer 39, a receptive hole 39h is formed at the position opposing to the organic EL layer OEL as a through hole passing through in the vertical direction in FIG. 4. Forming the receptive hole 39h in the reinforcement glass layer 39 results in a protruded part 39a serving as the strength reinforcement part being formed.

The thickness of the protruded part 39a (the reinforcement glass layer 39) is formed as a reinforcement thickness T2. The thickness T2 prevents the glass substrate 30 from being mechanically broken in a heating process or plasma treatment of a pixel forming step, which will be described later in step S12 shown in FIG. 5. As a result, it compensates the mechanical strength of the glass substrate 30. In the embodiment, the thickness of the reinforcement thickness T2 is set as the same as that of the minimum substrate thickness T1, i.e. 100 μm based on experiments or the like, but is not limited to this.

A micro lens 40 is formed in the receptive hole 39h. The micro lens 40 is a convex shaped lens, which has a hemispherical optical surface having sufficiently transparent to the wavelength of light emitted from the organic EL layer OEL. As shown in FIG. 4, the micro lens 40 is, formed so that the center position of the organic EL device 33 (organic EL layer OEL) is positioned concentric with the optical axis A.

The diameter (aperture diameter) of the micro lens 40 is equal to the diameter of the receptive hole 39h (the diameter of the organic EL layer OEL), i.e. the adjustment diameter R1. Accordingly, in the micro lens 40, light emitted from the organic EL layer OEL can be emitted to a side of the photosensitive layer 16a without deteriorating an image forming performance at its peripheral part.

Here, the micro lens 40 is located so that the distance between the top of the light emitting surface 40a and the photo sensitive layer 16a becomes the focal point distance Hf on image side of the micro lens 40. The micro lens 40 also is located so that the cross point between the optical axis A and the pass of light (parallel light bundle L1) emitted from the organic EL device 33 along the optical axis A is located on the photosensitive layer 16a. This cross point is the focal point F on image side. Thus, the light emitted from the micro lens 40 can form the desired exposed spot size on the photosensitive layer 16a thereby.

Consequently, light emitted from the organic EL layer OEL is incident on the micro lens 40. Then, the micro lens 40 converges the incident light so as to form an exposed spot on the photosensitive layer 16a. In this case, the angle (aperture angle θ1) formed from the center position of the organic EL layer OEL to the diameter of the micro lens 40 is increased by the minimum substrate thickness T1, which is the thickness of the glass substrate 30. Namely, the micro lens 40 can increase the efficiency of extract light emitted from the organic EL layer OEL, increasing exposure quantity, by the minimum substrate thickness T1, which is the thickness of the glass substrate 30.

Method for Manufacturing an Exposure Head

A method for manufacturing the exposure head 20 will be described below. FIG. 5 is a flow chart illustrating a method for manufacturing the exposure head 20. FIGS. 6 to 8 show a process for forming the exposure head 20.

As shown in FIG. 5, a glass paste layer bonding process is firstly performed (step S11). Namely, the glass paste layer Gp shown in FIG. 6 is bonded on the surface 30b for extract light of the glass substrate 30 so as to form the protruded part 39a.

The glass paste layer Gp in the embodiment is the paste, which is so-called a positive type photosensitive material that only the exposed part becomes soluble in the developer such as alkaline solution or the like, and is made of glass powders, binding resins, and photosensitive resins, etc. The glass powder is the mixture of lead oxides, boron oxide, and silicon oxide, or the mixture of zinc oxide, boron oxide, and silicon oxide, or the like. The powder has a softening point of approximately from 400 to 600 degrees centigrade. The binding resin is the resin, such as acrylic resin, that exhibits adhesiveness with respect to the glass substrate 30 by heating, being decomposed by burning, which will be described later, and removed from the reinforcement glass layer 39. The photosensitive resin is the resin that becomes soluble in the developer by exposing with exposure light having a given wavelength. Similarly to the binding resin, the photosensitive resin is decomposed and removed from the reinforcement glass layer 39 by burning described later.

In the glass paste layer bonding process, the glass paste layer Gp deposited on a supporting substrate (not shown) is thermally pressed to the surface 30b for extract light with a heating roller or the like. As a result, the glass paste layer Gp is bonded to the glass substrate 30 from the supporting substrate as shown in FIG. 6.

Then, a photo mask Mk, which has a given pattern corresponding to the receptive hole 39h (bulkhead DBw), is aligned to the glass paste layer Gp, so that the glass paste layer Gp is exposed and developed. Accordingly, the receptive hole 39h having the adjustment diameter R1 as a diameter is patterned on the glass paste layer Gp. After patterning the receptive hole 39h, the glass substrate 30 is subjected to an atmosphere of a given high temperature so as to decompose and remove organics (binding resin and photosensitive resin) contained in the glass paste layer Gp. Subsequently, the glass powder is melt and burned. As a result, the reinforcement glass layer 39, which is composed of the receptive hole 39h and the protruded part 39a, is formed on the surface 30b for extract light.

As shown in FIG. 5, after forming the protruded part 39b on the surface 30b for extract light, the process subsequently proceeds to a pixel forming process (step S12). Namely, the pixel 34 is formed on the surface 30a for forming a light-emitting device of the glass substrate 30.

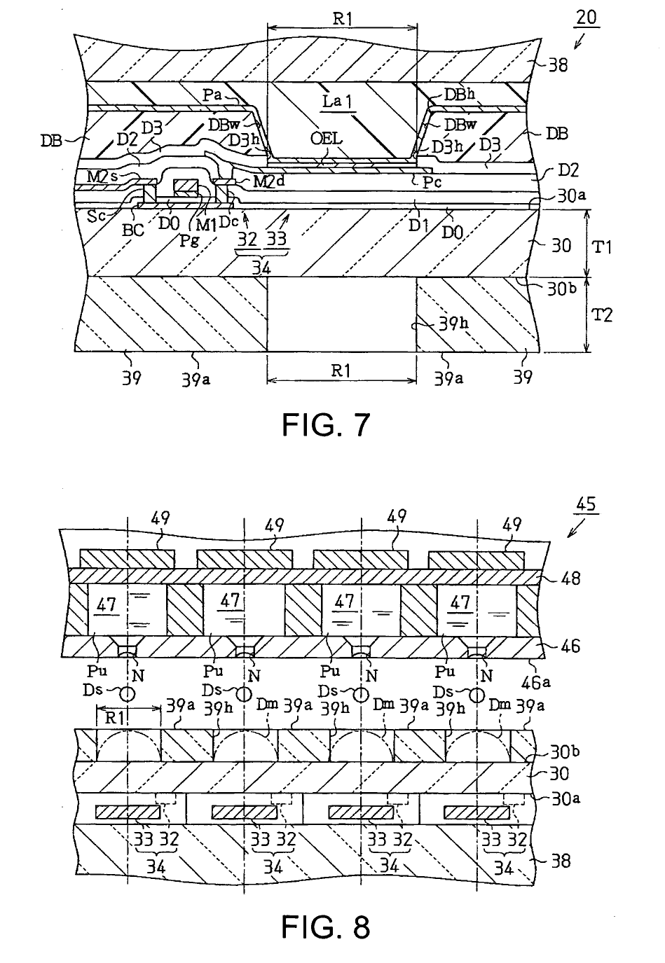

As shown in FIG. 7, in the pixel forming process, polysilicon film crystallized by an excimer laser or the like is firstly formed on all the surface 30a for forming a light-emitting device. The polysilicon film is patterned so as to form the channel film BC in each of the regions 31 for forming pixels. After forming the channel film BC, a silicon oxide layer or the like is deposited on entire surface of the channel film BC and the surface 30a for forming a light emitting device, forming the gate insulation layer D0. Further, a low resistive metal film such as tantalum is deposited on all the upper surface of the gate insulation layer D0. Then, the low resistive metal film is patterned, forming the gate electrode Pg on the gate insulation film D0. Then, after forming the gate electrode Pg, an n-type region (a source and drain regions) is formed in the channel film BC by ion doping with the gate electrode Pg as a mask.

After forming the source and drain regions in the channel film BC, a transparent conductive film such as ITO is deposited on the all surface of the gate electrode Pg and the gate insulation film D0 and patterned, forming the gate wiring M1 on the gate electrode Pg. After forming the gate wiring M1, a silicon oxide or the like is deposited on the all surfaces of the gate wiring M1 and the gate insulation film D0 by a plasma CVD method or the like, forming the first interlayer insulation film D1. Subsequently, a pair of contact holes is patterned at the position, which is located in the first interlayer insulation film D1 and corresponds to the source and drain regions. Then, the source contact Sc and the drain contact Dc are formed by embedding metal within the contact holes.

After forming contacts Sc and Dc, metal film such as aluminum is deposited over the entire surface of the contacts Sc and Dc, and the first interlayer insulation film D1 and patterned, forming the power source line M2s and the anode line M2d, which are connected to the contacts Sc and Dc. Next, a silicon oxide layer or the like is deposited on the all surfaces of the power source line M2s, the anode line M2d and the first interlayer insulation film D1, forming the second interlayer insulation film D2. A via hole is formed at the position, which is located in the second inter layer insulation film D2 and corresponds to a part of the anode line M2d. Subsequently, a transparent conductive film having light transparence property such as ITO is deposited inside the via hole and on the all surface of the second interlayer insulation film D2. Then, the transparent conductive film is patterned, forming the anode Pc connected to the anode line M2d.

After forming the anode Pc, silicon oxide or the like is deposited on the entire surface of the anode Pc and the second interlayer insulation film D2, forming a third interlayer insulation film D3. Then, the third interlayer insulation film D3 is etched, forming the position adjustment hole D3h at the position opposing to the receptive hole 39h.

After forming the position adjustment hole D3h, the material, which is made of light curable resin, for forming the bulkhead is coated inside the position adjustment hole D3h and on the entire surface of the third interlayer insulation film D3. Then, the material for forming the bulkhead is patterned, forming the bulkhead layer DB including the bulkhead DBw (the conical hole DBh).

Then, a material for forming a hole transport layer is discharged into the position adjustment hole D3h (the conical hole DBh) by an inkjet method, dried and solidified, as forming a hole transport layer. Further, a material for forming a light-emitting layer (light-emitting layer forming material) is discharged to the surface of the hole transport layer by an inkjet method, dried and solidified, as forming a light-emitting layer. As a result, the organic EL layer OEL having the adjustment diameter R1 as a diameter is formed. After forming the organic EL layer OEL, the cathode Pa made of a metal film such as aluminum is deposited on the entire surface of the organic EL layer OEL and the third interlayer insulation film D3. As a result, the organic EL device 33 is formed that is composed of the anode Pc, the organic EL layer OEL, and the cathode Pa.

After forming the pixel device 34 on the surface 30a for forming a light-emitting device, an adhesive made of epoxy resin or the like is coated on the entire surface of the pixel device 34 (cathode Pa), forming an adhesive layer La1. The sealing substrate 38 and the glass substrate 30 are bonded with the adhesive layer La1 therebetween. As a result, the pixel device 34 (TFT 32 and organic EL device 33) sealed with the sealing substrate 38 is formed on the surface 30a for forming a light-emitting device.

In this time, the glass substrate 30 is suffered with a mechanical load by various heating processes, plasma treatment and the like. However, the glass substrate 30 can be prevented from being mechanically broken since its mechanical strength is compensated by the protruded part 39a (reinforcement glass layer 39) having the reinforcement thickness T2.

As shown in FIG. 5, after forming the pixel device 34 on the surface 30a for forming a light-emitting device, the process proceeds to a droplet discharge process to discharge a droplet to the receptive hole 39h (step S13). FIG. 8 is an explanatory view illustrating a droplet discharge process. First, a droplet discharging device for discharging a droplet will be explained.

As shown in FIG. 8, a droplet discharging head 45, which is included in the droplet discharging device, is provided with a nozzle plate 46. On the lower surface of the nozzle plate 46 (a surface 46a for forming nozzles), a plurality of nozzles N, which discharges an ultraviolet cured resin Pu serving as a functional liquid, is formed vertically in FIG. 8. A supply chamber 47, which can supply the ultraviolet cured resin Pu to inside each of the nozzles N by communicating a storage tank not shown, is formed on each of the nozzles N. On each supply chamber 47, a vibrating plate 48 is provided that increases and decreases the volume inside the supply chamber 47 by oscillating in the vertical direction in FIG. 8. A piezoelectric device 49, which vibrates the vibration plate 48 with an expanding-contracting movement in the vertical direction in FIG. 8, is respectively disposed at the position, which is located on the vibration plate 48, opposing to the supply chamber 47.

The glass substrate 30 is set and transferred to the droplet discharging device so that the surface 30b for extract light opposes to the surface 46a for forming nozzles as shown in FIG. 8. In addition, the glass substrate 30 is positioned so that the surface 30a for forming a light-emitting device is in parallel with the surface 46a for forming nozzles, and the center position of each receptive hole 39h is located directly under each of nozzles N.

Here, when inputting a driving signal for discharging a droplet to the droplet discharging head 45, the volume of the supply chamber 47 increases and decreases with the expanding-contracting movement of the piezoelectric device 49 based on the driving signal. In this time, when the volume of the supply chamber 47 is decreased, the ultraviolet cured resin Pu corresponding to the decreased volume is discharged from each of nozzles N as a micro droplet Ds. Each micro droplet Ds discharged is landed on the surface 30b in each receptive hole 39h. Subsequently, when the volume of the supply chamber 47 is increased, the ultraviolet cured resin Pu corresponding to the increased volume is supplied inside the supply chamber 47 from the storage tank not shown. Namely, the droplet discharging head 45 discharges the ultraviolet cured resin Pu to the receptive hole 39h at a given volume by increasing and decreasing the volume of the supply chamber 47. A plurality of micro droplets Ds landed in the receptive hole 39h forms a droplet Dm, which has a hemispherical surface, by its surface tension, etc., as shown with the chain double dashed line in FIG. 8. In this time, the droplet discharging head 45 discharges the micro droplet Ds so that the diameter of the droplet Dm becomes the diameter of the receptive hole 39h, i.e. the adjustment diameter R1.

As shown in FIG. 5, after forming the droplet Dm in the receptive hole 39h, a lens forming process is performed in which the droplet Dm is cured so as to form the micro lens 40 (step S14). The droplet Dm is cured by irradiating ultraviolet rays. As a result, the micro lens 40 having the adjustment diameter R1 as an aperture diameter is formed on the surface 30b for extract light.

Next, effects of the first embodiment will be described below.

(1) In the embodiment, the thickness of the glass substrate 30 is formed as the minimum substrate thickness T1, while the protruded part 39a is formed on the surface 30b of the glass substrate 30, compensating the mechanical strength of the glass substrate 30. Accordingly, the aperture angle θ1 of the micro lens 40 can be increased by the minimum substrate thickness T1, which is the thickness of the glass substrate 30. The increased angle allows the exposure head 20, which improves the efficiency of extract light emitted from the organic EL device 33, to be manufactured.

(2) In addition, the micro lens 40 is formed on the surface 30 for extract light, which has been formed in flat and smooth (arithmetic average roughness Ra is 1 μm and below) in advance. As a result, variations in the shape of the micro lens 40 can be controlled and suppressed.

(3) In the embodiment, the receptive hole 39h and the conical hole DBh (bulkhead DBw) are formed so as to be opposed. The ultraviolet cured resin Pu is discharged into the receptive hole 39h, forming the micro lens 40, while the material for forming the organic EL layer OEL is discharged into the conical hole DBh (bulkhead DBw), forming the organic EL layer OEL. Accordingly, the formed position of the micro lens 40 can be aligned with the position opposing to the organic EL layer OEL. As a result, variations in formed position of the micro lens 40 can be controlled and suppressed.

(4) Further, the receptive hole 39h is formed so that its diameter is equal to the adjustment diameter R1 corresponding to the aperture diameter of the micro lens 40, allowing the aperture diameter of the micro lens 40 to be surely equal to the adjustment diameter R1. As a result, variations in formed position of the micro lens 40 can be controlled and suppressed.

### Second Embodiment

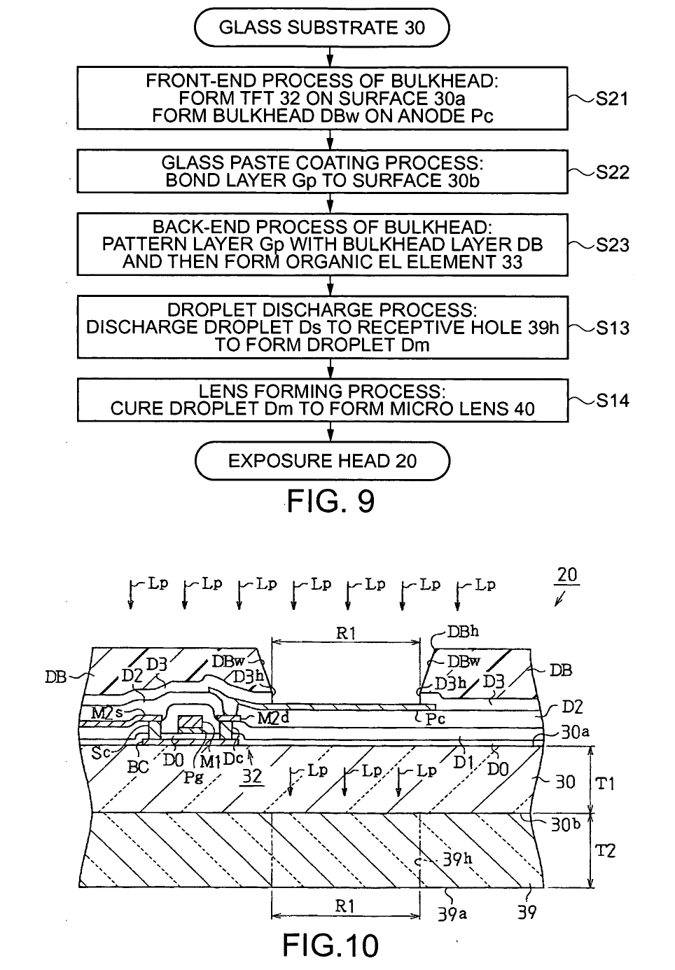

Next, a second embodiment of the invention will be explained with reference to FIG. 9 and FIG. 10. Here, in the second embodiment differs from the first embodiment in that the method for manufacturing the receptive hole 39h and the bulkhead DBw (bulkhead layer DB) are changed. Other than these, the second embodiment has the same structure of the first embodiment. Therefore, the method for manufacturing the receptive hole 39h and the bulkhead DBw will be minutely explained below. FIG. 9 is a flow chart illustrating a method for manufacturing the exposure head 20 in the second embodiment. FIG. 10 shows a process for forming the exposure head 20.

As shown in FIG. 9, a front-end process of the bulkhead is performed in which the TFT 32 is formed on the surface 30a for forming a light-emitting device of the glass substrate 30, and then the bulkhead DBw (conical hole DBh) is formed in the bulkhead layer DB on the anode Pc (step S21). Here, the bulkhead layer DB in the embodiment absorbs exposure light Lp, which will be described later referring to FIG. 10, exposing the glass paste layer Gp.

As shown in FIG. 9, after forming the bulkhead DBw on the anode Pc, a glass paste coating process is performed (step S22). Namely, a glass paste is coated on the surface 30b for extract light of the glass substrate 30 so as to form the glass paste layer Gp. The glass paste layer Gp in the embodiment is the paste, which is so-called a positive type photosensitive material that only the exposed part becomes soluble in a developer such as alkaline solution or the like, and is made of glass powders and photosensitive resins, etc.

As shown in FIG. 9, after forming the glass paste layer Gp on the surface 30b for extract light, a back-end process of the bulkhead is performed. Namely, the glass paste layer Gp is exposed by the exposure light Lp with the bulkhead layer DB as a mask, being developed (step S23). Accordingly, the receptive hole 39h, which is the circular hole having the adjustment diameter R1, can be patterned at the position opposing to the conical hole DBh of the bulkhead layer DB without preparing a photo mask for exposing the glass paste layer Gp. Then, the glass paste layer Gp is burned, so that the receptive hole 39h is formed in the reinforcement glass layer 39. As a result, the protruded part 39a can be formed.

As shown in FIG. 9, after forming the reinforcement glass layer 39 by patterning the receptive hole 39h, the organic EL layer OEL is formed in the bulkhead layer DB so as to form the organic EL device 33. Then, the micro lens 40 is formed in the receptive hole 39h (steps S13 and S14).

Accordingly, the receptive hole 39h (micro lens 40) can be formed self-alignmently at the position opposing to the conical hole DBh (organic EL layer OEL) without preparing a photo mask for exposing the glass paste layer Gp.

The above-mentioned embodiments may be changed as the followings.

In the embodiments, the protruded part 39a is formed by burning the glass powder, but not limited to this. For example, metal film, which as long as it can be formed in the thickness that can compensate the mechanical strength of the glass substrate 30, also may be used.

In the embodiments, the transparent substrate is embodied as the glass substrate 30. However, a plastic substrate such as polyimide resin or the like may be used in addition to the glass substrate. Any transparent substrates may be used which as long as it can transmit light emitted from the organic EL layer OEL.

In the embodiments, the droplet Dm is formed in the receptive hole 39h by discharging the ultraviolet cured resin Pu. In addition, the droplet Dm may be formed by discharging the ultraviolet cured resin Pu after performing a liquid repellency treatment (e.g. fluorine plasma treatment or coating of liquid repellency materials) to the inner circumferential surface of the receptive hole 39h. Accordingly, the micro droplet Ds does not wet and spread on the inner circumferential surface of the receptive hole 39h. As a result, the droplet Dm having a hemispherical surface can be uniformly formed.

In the embodiments, the aperture diameter of the micro lens 40 is formed as the same size of the inner diameter (adjustment diameter R1) of the organic EL layer OEL. However, the aperture diameter is not limited to this size. For example, the aperture diameter may be formed as doubled size of the adjustment diameter R1. Namely, any aperture diameter may be employed as long as it can form the exposed spot of a desired size corresponding to each organic EL layer OEL without deteriorating the image forming performance at the peripheral part of the micro lens 40.

In the embodiments, the micro lens 40 is embodied as the hemispherical shaped convex lens. However, it may be embodied as a half-cylindrical lens or a concave lens. As a result, the efficiency of diffusing light emitted from the organic EL device 33 can be further increased.

In the embodiments, the micro lens 40 is formed with the ultraviolet cured resin Pu. However, it may be formed with thermosetting resins, for example. Any functional liquid may be employed as long as it can be cured in the receptive hole 39h.

In the embodiments, the distance between the top of the light emitting surface 40a and the photo sensitive layer 16a becomes the focal point distance Hf on image side so that the light emitted from the organic EL layer OEL is converged on the photo sensitive layer 16a. However, the distance is not limited to be the focal point distance Hf on image side. For example, the distance may be the distance to obtain the same magnified image of the organic EL layer OEL.

In the embodiment, the micro lenses 40 is formed by the droplet discharging device. Forming the micro lens 40 is not limited to this, but the micro lenses 40, which is formed by a replica method or the like, may be provided in the receptive hole 39h.

In the embodiments, each pixel device 34 is provided with one TFT 32 controlling the emission of the organic EL device 33. The number of TFTs 32 is not limited to be one, each pixel device 34 may be provided with two or more TFTs 32. Alternatively, the TFT 32 may not be included in the glass substrate 30.

In the embodiments, the organic EL layer OEL is formed by the inkjet method. The method for forming the organic EL layer OEL is not limited to the inkjet method. The spin coat method, vacuum vapor deposition method, or the like may be exemplified.

In the embodiments, the organic EL layer OEL is formed with the polymer organic material. However, low-molecular organic materials may be employed. Further, an EL layer formed with inorganic materials may also be employed.

In the embodiments, the electro-optical device is embodied as the exposure head 20. However, the electro-optical device is not limited to this. Examples may include backlights mounted in liquid crystal displays, or field effect devices (FEDs, SEDs or the like) that include electron-emitter device having a flat shape and utilize the light emitted from the fluorescent material caused by the electron emitted from the device.

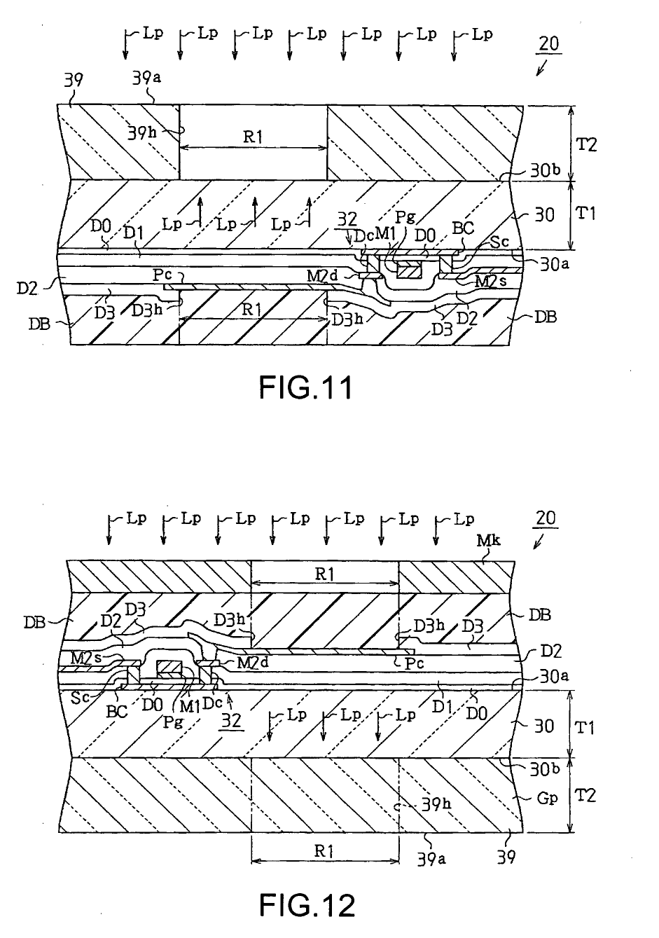

In the second embodiment, the glass paste layer Gp is exposed with the bulkhead DBw of the bulkhead layer DB as a mask. The step is not limited to this. For example, the reinforcement glass layer 39 (receptive hole 39h) may be formed before forming the bulkhead layer DB as shown in FIG. 11. After forming the receptive hole 39h, the bulkhead forming material may be coated entire the surface of the third interlayer insulation film D3. Then, the bulkhead forming material may be exposed and developed with the reinforcement glass layer 39 as a mask.

Accordingly, the conical hole DBh (bulkhead DBw) can be formed at the position opposing to the receptive hole 39h in the reinforcement glass layer 39 without preparing a photo mask for exposing the bulkhead forming material. In this case, it is preferable that the reinforcement glass layer 39 adsorbs the exposure light Lp exposing the bulkhead forming material, and the bulkhead forming material is composed of a positive type photosensitive material that only the exposed part is soluble in a developer.

Moreover, as shown in FIG. 12, the bulkhead forming material and the glass paste layer Gp may be simultaneously exposed, forming patterns corresponding to the conical hole DBh (bulkhead DBw) and the receptive hole 39h. Accordingly, the conical hole DBh (bulkhead DBw) can be formed at the position opposing to the receptive hole 39h without preparing a photo mask for exposing the bulkhead forming material or glass paste layer Gp. In this case, it is preferable that the bulkhead forming material and the glass paste layer Gp are composed of a positive type photosensitive material that only the exposed part is soluble in a developer.

1. A transparent substrate, comprising:
a light incident surface;
a light extract surface;
a micro lens formed on the light extract surface; and
a strength reinforcement part compensating a mechanical strength of the transparent substrate, the strength reinforcement part surrounding the micro lens and being protruded from the light extract surface, and light entered to a side of the light incident surface being emitted from a side of light extract surface.

2. The transparent substrate according to claim 1, the strength reinforcement part including a through hole reaching to the light extract surface, the strength reinforcement part being deposited on the light extract surface, and the micro lens being formed in the through hole.

3. The transparent substrate according to claim 2, the micro lens having a hemispherical optical surface, and the through hole being a circular hole having an inner diameter corresponding to an aperture diameter of the micro lens.

4. The transparent substrate according to claim 2, the transparent substrate being a glass substrate, and the strength reinforcement part being a photosensitive glass paste layer deposited on the light extract surface, being burned after patterning the through hole therein.

5. An electro-optical device, comprising:
a transparent substrate having a light-emitting device forming surface and a light extract surface opposing to the light-emitting device forming surface;
a light-emitting device formed on the light-emitting device forming surface;
a micro lens formed at a position on the light extract surface and opposing to the light-emitting device; and
a strength reinforcement part compensating a mechanical strength of the transparent substrate, the strength reinforcement part surrounding the micro lens, light emitted from the light-emitting device being emitted from a side of the light extract surface.

6. The electro-optical device according to claim 5, wherein the strength reinforcement part is deposited on the light extract surface and includes a through hole reaching to the light extract surface, and the micro lens is formed in the through hole.

7. The electro-optical device according to claim 6, wherein the micro lens is a convex shaped lens having a hemispherical optical surface, and the through hole is a circular hole having an inner diameter corresponding to an aperture diameter of the micro lens.

8. The electro-optical device according to claim 6, wherein the transparent substrate is a glass substrate and the strength reinforcement part is one that is formed by patterning the through hole in a photosensitive glass paste layer, which is deposited on the light extract surface, and burning the photosensitive glass paste layer.

9. The electro-optical device according to claim 5, wherein the light-emitting device is an electroluminescent device including:
a transparent electrode formed on a side of the light extract surface;
a backside electrode formed so as to oppose to the transparent electrode; and
a light-emitting layer formed between the transparent electrode and the backside electrode.

10. The electro-optical device according to claim 9, wherein the light-emitting layer is formed with an organic material, and the electroluminescent device is an organic electroluminescent device.

11. An image forming device, comprising:
a charging unit charging an outer circumferential surface of an image carrier;
an exposure unit exposing the charged outer circumferential surface of the image carrier so as to form a latent image;
a development unit developing a developed image by supplying a colored particle to the latent image; and
a transfer unit transferring the developed image to a transfer medium, the exposure unit being provided with the electro-optical device according to claim 5.

12. A method for manufacturing an electro-optical device, comprising:
depositing a strength reinforcement layer on a light extract surface of a transparent substrate;
forming a through hole reaching to the light extract surface in the strength reinforcement layer so as to form a strength reinforcement part compensating a mechanical strength of the transparent substrate;
forming a light-emitting device at a position on a light-emitting device forming surface of the transparent substrate, the light-emitting device forming surface opposing to the light extract surface, the position opposing to the through hole; and
forming a micro lens in the through hole, the micro lens emitting light emitted from the light-emitting device.

13. The method for manufacturing an electro-optical device according to claim 12, the light-emitting device being an electroluminescent device having a light-emitting layer, the light-emitting layer being formed by discharging a droplet in a bulkhead and curing the discharged droplet, the droplet being composed of a light-emitting layer forming material.

14. The method for manufacturing an electro-optical device according to claim 13 further comprising:
exposing the strength reinforcement layer made of a photosensitive material with the bulkhead as a mask; and
developing the strength reinforcement layer so as to form the through hole.

15. The method for manufacturing an electro-optical device according to claim 13 further comprising:
exposing the bulkhead layer made of a photosensitive material with the strength reinforcement part as a mask; and
developing the bulkhead layer so as to form the bulkhead.

16. The method for manufacturing an electro-optical device according to claim 13 further comprising:
simultaneously exposing the strength reinforcement layer made of a photosensitive material and the bulkhead layer made of a photosensitive material so as to form patterns corresponding to the through hole on the strength reinforcement layer and the bulkhead on the bulkhead layer; and
exposing the strength reinforcement layer and the bulkhead layer so as to form the through hole and the bulkhead.
